(19) United States
(12) Patent Application Publication
(10) Pub. No.: US 2014/0183012 A1
(43) Pub. Date: Jul. 3, 2014

(54) Circuit Breaker Handle Extension with Positive Stop Features

(71) Applicant: Eaton Corporation, Cleveland, OH (US)

(72) Inventors: Scott Ray Lanning, Conway, PA (US); Ken Martin Fischer, Finleyville, PA (US); Brian Scott Jansto, Beaver Falls, PA (US)

(21) Appl. No.: 13/756,533

(22) Filed: Feb. 1, 2013

Related U.S. Application Data
(60) Provisional application No. 61/748,017, filed on Dec. 31, 2012.

(51) Int. Cl. H01H 9/20

(52) U.S. Cl. CPC H01H 9/20
USPC 200/43.16

(57) ABSTRACT

An improved circuit breaker switch handle extension is described. The circuit breaker switch handle extension is used to control and limit operation of a circuit breaker switch handle to which it is attached. The handle extension includes positive stop features that prevent damage or destruction of the circuit breaker switch handle when excessive or undesirable force is applied to the handle extension.

### CLAIM OF PRIORITY TO PROVISIONAL APPLICATION

### Incorporation by Reference

This application claims priority under 35 USC 119 to U.S. Provisional Application No. 61/748,017, filed Dec. 31, 2012 entitled “CIRCUIT BREAKER HANDLE EXTENSION WITH POSITIVE STOP FEATURES” (attorney docket number ETN-060-PROV); the contents of Provisional Application No. 61/748,017 filed Dec. 31, 2012 are hereby incorporated by reference as if set forth in full.

### FIELD

The present disclosure relates generally to circuit breakers. More specifically, the present disclosure relates to devices and methods that decrease damage to circuit breaker switches.

### BACKGROUND

Circuit breaker switch handles are well known. Circuit breakers are used to interrupt flow of electricity when a fault is detected in a circuit. Upon detection of a fault, a physical switch in the circuit breaker moves from an “ON” position an “OFF” position. in doing so, the switch opens the circuit, which disconnects an electrical load from a power source. Auer a fault occurs, circuit breakers typically require manual attendance to move the circuit breaker switch back to the “ON” position through use of a handle.

Circuit breakers are often manufactured encased in various types of materials. Some circuit breakers are encased in plastic molding, while others are housed within metal panels. Regardless of the type of encasement, it is desirable to prevent direct access to the electrically conductive components of the circuit breaker. However, these conductive components must also be accessible by a technician if the components require repair or replacement. Accordingly, circuit breaker manufacturers have adapted covers to include apertures through which circuit breaker switch handles may extend for ease of access.

Circuit breakers may contain components such as springs that reduce or minimize potential for unwanted movement of the switch. For example, a circuit breaker may employ one or more springs that maintain a desired position of the switch, whether “ON” or “OFF”, unless significant force is applied to change the switch position. In order to more easily change the current state of the switch, manufacturers have created handles, and handle extensions for circuit breaker switches to ease use by an operator. Because handles and their extensions extend distally away from a pivot point of the switch, the lever-arm becomes elongated and upon application of force by a user or technician, a larger torque moment is placed on a switch axis, thereby more easily overcoming the current position of the switch, whether “ON” or “OFF.” Because less force is required on the lever-arm to produce the same torque moment necessary to change the status of the current position of the switch, the handles or their extensions make the circuit breaker easier to operate.

However, because a handle or a handle extension creates a larger lever-arm on the switch, the user or technician is likely to apply force in excess of what is required to move the position of the circuit breaker switch. This excessive force can cause the handle to deform or break. If the switch handle has been completely sheared away, it may prevent further operation of the switch via conventional means. Also, such damage may expose electrically conducting components within the circuit breaker and increase possibility of electrocution. Once damaged, a trained professional may be required to safely repair or replace damaged electrical components

Accordingly, a need exists for a device and method that eases operation of circuit breaker handle switches. A need also exists for a device and method that prevents application of excess force to the handle or handle extension, thereby minimizing the potential for damage to the switch or electrical components.

### SUMMARY

The present disclosure provides a device for the protection of circuit breaker switches and handles.

One aspect of the present teachings is to provide an elongated handle extension adapted to be mated with a circuit breaker switch handle extending along the axis of the circuit breaker switch so that a user may easily overcome a current switch status of a spring-loaded circuit breaker switch. Another aspect of the present apparatus in accordance with the present teachings is to provide an elongated handle extension having a mechanical positive stop feature that reduces damage to the circuit breaker switch or switch handle that can result from an excessive application of force on the switch handle. Yet another purpose of the presently described apparatus is to provide an elongated handle extension attached to a circuit breaker switch having a mechanical positive stop feature applicable to both the “ON” and “OFF” positions of the switch.

In one embodiment, an elongated handle extension is provided wherein the handle extension is adapted to mate with a circuit breaker switch handle extending away from the circuit breaker switch. In one embodiment, the elongated handle extension is attached to a circuit breaker switch handle that extends through an aperture in the circuit breaker cover. In one embodiment, the elongated handle extension comprises a base and a main body. Said main body is substantially rectangular having two long sides and whose surfaces are substantially perpendicular to the surfaces comprising the base. In this embodiment, the main body approximately bisects the base. The base has an upper portion that extends horizontally to said lower portion.

In one embodiment, the handle extension creates a minor angle and a major angle when mated with the circuit breaker switch handle. In one embodiment, a side in which the major and minor angles exist alternate according to whether the circuit breaker switch is in an “ON” or “OFF” position. in one embodiment, the base has a lower portion having two surfaces that alternatively mate with the circuit breaker cover. The two surfaces exist on each side of the lower base portion and are bisected by the main body of the handle extension. When the switch is in an “ON” position and the handle extension is in use, one surface lies in a plane that is approximately parallel to, and in static contact with, a portion of the circuit breaker case cover creating a minor angle with the handle extension. When the switch is in the “OFF” position, the second surface lies in a plane approximately parallel to, and in static contact with, the portion of the circuit breaker case cover that creates the minor angle with the handle extension. Each of the two surfaces comprises alternate legs of the lower portion of the base that extends perpendicularly away from the main body.

In one embodiment, the legs serve as positive stop elements of the handle extension for the “ON” and “OFF” positions of the switch. The legs function as positive stop elements by having parallel surfaces that interface with each side of the circuit breaker case. in one embodiment, the legs are substantially perpendicular to the main body, and are connected to the main body through an upper portion of the base, which is a surface that extends horizontally away from the main body. When force is applied to either side of the main body of the handle extension, the curved upper base surface carries a compressive force axially through the surface, thereby reducing the bending or shearing forces that would otherwise exist in the main body and substantially perpendicular legs in the absence of such curved upper base surface.

Further embodiments of the disclosure are shown in the specification, drawings and claims of the present application as set forth below.

### BRIEF DESCRIPTION OF THE DRAWINGS

FIG. 1 is a three-dimensional isometric view of an exemplary circuit breaker handle extension made in accordance with the present teachings having a positive stop feature.

FIG. 2 is a cross-sectional view of a circuit breaker and handle and handle extension wherein the handle does not include a positive stop feature.

FIG. 3 is cross-sectional view of an exemplary circuit breaker handle and handle extension made in accordance with the present teachings and having a positive stop feature.

### DETAILED DESCRIPTION

The disclosed teachings provide advantageous apparatus designed to protect circuit breaker switches and handles. The improved circuit breaker switch handle described herein eases use of circuit breakers when a user or technician switches a circuit breaker from an “ON” to an “OFF” position and vice versa. As shown in the figures described in more detail below, an improved circuit breaker switch handle extension apparatus provides the foregoing advantages using a circuit breaker (101), a circuit breaker switch handle (103), and a circuit breaker handle extension (105) attached to the circuit breaker switch handle (103). Said circuit breaker handle extension comprises a main body (107) and a base (109), said base further comprising an upper base portion (111) and a lower base portion (113). Said lower base portion (113) comprises two legs (115) that are substantially perpendicular to and generally bisected by the main body (107) of the switch handle extension (105). The legs each have surfaces (117) that are approximately parallel to and adapted to statically mate with a circuit breaker cover (121) on alternate sides of the circuit breaker switch handle (103). Said upper base portions (111) include surfaces (119) extending from the main body (107) to each of the legs (115) to transmit axial load upon application and to reduce shearing forces in the legs (115). The base (109), and its various component parts comprise a positive stop feature of the improved circuit breaker switch handle.

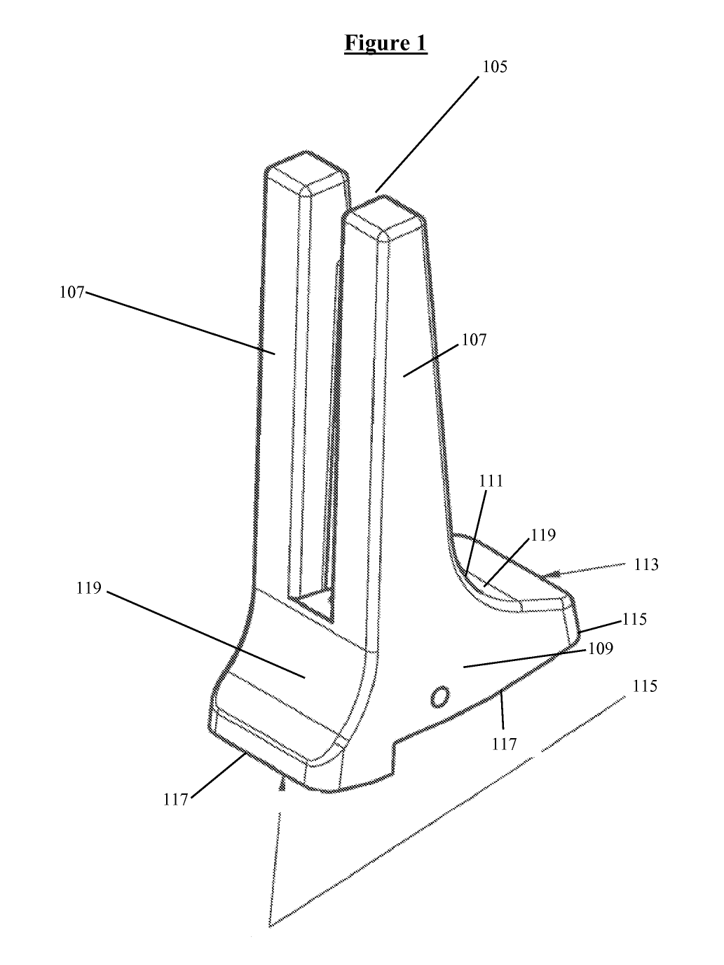

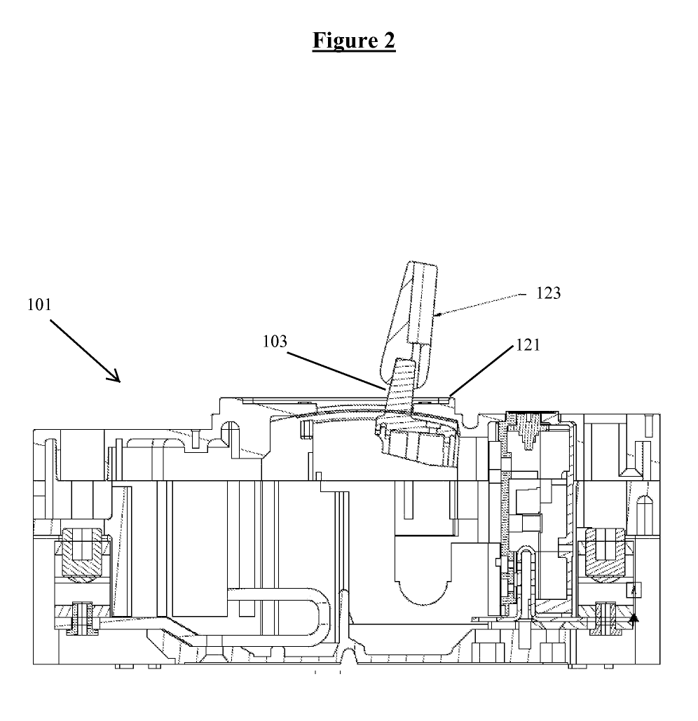

FIG. 1 is a three-dimensional isometric view of an exemplary embodiment of a circuit breaker handle extension (105) made in accordance with the present teachings have a positive stop feature (109) and adapted to mate with a circuit breaker cover (121) (shown in FIG. 2). A circuit breaker (101) and a circuit breaker switch handle (103) are shown in FIG. 2. As shown in FIG. 1, the circuit breaker handle extension (105) comprises a main body (107) and a base (109), said base further comprising an upper base portion (111) and a lower base portion (113). Said lower base portion (113) comprises two legs (115) which are substantially perpendicular to, and generally bisected by, the main body (107) of the handle extension (105). The upper base portions (111) include curved surfaces (119) that extend from the main body (107) to each of the legs (115), thereby mechanically coupling the main body (107) to the legs (115). Configured in this way, the circuit breaker handle extension (105) includes stop features that prevent breakage to the circuit breaker switch during use. The legs (115) include bottom surfaces (117) designed to contact the circuit breaker cover during use and therefore create a positive stop feature preventing damage to the circuit breaker and/or the switch.

FIG. 2 is a cross-sectional view of a circuit breaker (101) having a circuit breaker switch handle (103) and handle extension (123). The handle extension (123) does not include a positive stop feature such as that provided by the circuit breaker handle extension (105) of FIG. 1. Owing to the fact that the circuit breaker handle extension (123) does not include a positive stop feature when forced toward the circuit breaker case (121) the switch handle (103) and handle extension (123) are subject to over-application of mechanical force during operation. Consequently, the excessive force disadvantageously can damage or destroy the switch handle (103) and/or the circuit breaker (101).

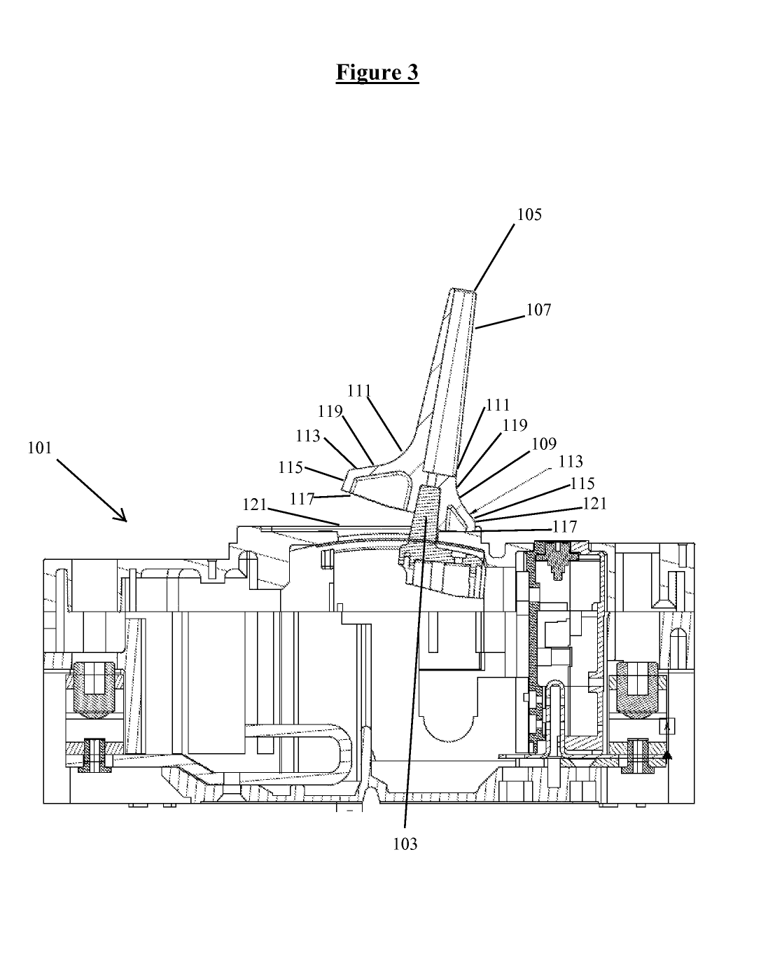

FIG. 3 is a cross-sectional view of an exemplary circuit breaker handle extension (105) made in accordance with the present teachings. The handle extension (105) includes a positive stop feature (109) that prevents excessive movement of the handle extension (105) and circuit breaker switch handle (103) when the handle extension comes into contact with the circuit breaker cover (121). A circuit breaker (101) and a circuit breaker switch handle (103) are shown in FIG. 3. As shown in FIG. 3, a circuit breaker handle extension (105) of the current disclosure is attached to a circuit breaker switch handle (103). The circuit breaker handle extension comprises a main body (107) and a base (109). The base further includes an upper base portion (111) and a lower base portion (113). Said lower base portion (113) includes two legs (115) that are substantially perpendicular to, and generally bisected by, the main body (107) of the handle extension (105). The legs each have surfaces (117) which are parallel to, and designed to make contact with the circuit breaker cover (121) on opposite sides of the circuit breaker switch (103). Said upper base portions (111) include curved surfaces (119) extending from the main body (107) to each of the legs (115).

As shown in FIG. 3, the legs (115) of the lower base portion (113) of the circuit breaker handle extension (105) restrict excessive and undesired movement of the handle extension (105) and circuit breaker switch handle (103) when the bottom surfaces (117) of the legs (115) come into contact with the circuit breaker cover (121). The handle extension (105) and attached circuit breaker switch handle (103) are thereby advantageously prevented from “over-travel” and possible damage when the circuit breaker switch is moved from an “ON” position to an OFF position, and vice versa. By restricting movement of the breaker switch handle (103) beyond a point of contact between the bottom surfaces (117) of the legs (115) and the circuit breaker cover (121), the present inventive circuit breaker handle extension (105) prevents inadvertent damage to the circuit breaker switch handle (103), circuit breaker (101) and circuit breaker cover (121) during operation of the circuit breaker (101).

What is claimed is:

1. An elongated circuit breaker handle extension having positive stop features and adapted for use with a circuit breaker switch handle, comprising:
a base portion adapted to mechanically mate with a circuit breaker switch handle, wherein the circuit breaker switch handle extends along a longitudinal axis of a spring-loaded circuit breaker switch; and wherein the circuit breaker switch handle extends through in an aperture of a cover of the circuit breaker switch; and wherein the base portion comprises an upper base portion and a lower base portion, and wherein the lower base portion is adapted to mechanically couple to the cover of the circuit breaker switch; and
a main body portion, coupled to the base portion, wherein the main body portion is substantially rectangular in shape, and wherein the main body portion includes at least two sides having surfaces that are substantially perpendicular to the base portion and which substantially bisect the base portion;
wherein the base portion of the circuit breaker handle extension includes positive stop features that prevent excessive movement of the handle extension and circuit breaker switch handle during use.

2. The handle extension of claim 1, wherein the positive stop features of the base portion includes at least two legs that come into contact with the cover of the circuit breaker switch when the handle extension is moved beyond a desired switch position, thereby preventing the handle extension from being moved beyond a desired ON or OFF position.

3. The handle extension of claim 2, wherein the legs provide the positive stop features by alternately coming into physical contact with the cover of the circuit breaker switch.

4. The handle extension of claim 2, wherein the upper base portion comprises a surface that curvedly extends away from the main body to gradually form substantially perpendicular lower leg portions of the base portion.
